(19) United States
(12) Patent Application Publication
(10) Pub. No.: US 2026/0368870 A1
(43) Pub. Date: Nov. 19, 2026

(54) INFORMATION PROCESSING SYSTEM, INFORMATION PROCESSING APPARATUS, INFORMATION PROCESSING METHOD, AND NON-TRANSITORY COMPUTER READABLE MEDIUM

(71) Applicant: NEC Corporation, Minato-ku, Tokyo (JP)

(72) Inventors: Yuho SHOJI, Tokyo (JP); Takahiro TOIZUMI, Tokyo (JP)

(73) Assignee: NEC Corporation, Minato-ku, Tokyo (JP)

(21) Appl. No.: 19/121,854

(22) PCT Filed: Nov. 4, 2022
(86) PCT No.: PCT/JP2022/041157

§ 371 Date: Apr. 17, 2025

(51) Int. Cl. G06T 7/00; G06T 3/4046; G06T 7/62

(52) U.S. Cl. CPC G06T 7/0002; G06T 3/4046; G06T 7/62; G06T 2207/20081; G06T 2207/20084; G06T 2207/30168; G06T 2207/30201

(57) ABSTRACT

An information processing system (100) includes a quality estimation unit (111) and an image processing unit (113). The quality estimation unit (111) estimates quality information of a target image. The image processing unit (113) processes the target image by using a neural network according to a network policy to be decided based on quality information of the target image.

### TECHNICAL FIELD

The present disclosure relates to an information processing system, an information processing apparatus, an information processing method, and a medium.

### BACKGROUND ART

Generally, in iris recognition, in a case where quality such as a resolution of an image is low, recognition performance may be lowered. Therefore, in iris recognition, it is desirable to photograph a recognition target by using a high-resolution photographing apparatus, however, it may be difficult to use a high-resolution photographing apparatus in view of an installation space, a cost, and the like of the photographing apparatus.

For example, Patent Document 1 discloses using a predetermined number of captured images, and generating an iris recognition image of a second resolution higher than a first resolution of the captured images at an execution time of iris recognition. As an example thereof, Patent Document 1 discloses converting a 1×1 pixel of a captured image into 2×2 pixels from eight captured images being consecutively captured, and generating a recognition image whose resolution is two times.

### RELATED DOCUMENT

### Patent Document

Patent Document 1: Japanese Patent Application Publication No. 2009-282925

### SUMMARY

### Technical Problem

An object of the present disclosure is to improve the technique described in the above-described related document.

### Solution to Problem

One aspect of the present invention provides an information processing system including:
a quality estimation unit that estimates quality information of a target image; and
an image processing unit that processes the target image by using a neural network according to a network policy to be decided based on quality information of the target image.

One aspect of the present invention provides an information processing apparatus including:
a quality estimation unit that estimates quality information of a target image; and
an image processing unit that processes the target image by using a neural network according to a network policy to be decided based on quality information of the target image.

One aspect of the present invention provides an information processing method including,
by one or more computers:
estimating quality information of a target image; and
processing the target image by using a neural network according to a network policy to be decided based on quality information of the target image.

One aspect of the present invention provides a medium recording a program for causing one or more computers to execute:
estimating quality information of a target image; and
processing the target image by using a neural network according to a network policy to be decided based on quality information of the target image.

### BRIEF DESCRIPTION OF THE DRAWINGS

FIG. 1 is a diagram illustrating an overview of an information processing system according to an example embodiment 1.

FIG. 2 is a diagram illustrating an overview of an information processing apparatus according to the example embodiment 1.

FIG. 3 is a flowchart illustrating an overview of information processing according to the example embodiment 1.

FIG. 4 is a diagram illustrating a configuration example of the information processing system according to the example embodiment 1.

FIG. 5 is a diagram illustrating a configuration example of a neural network according to the example embodiment 1.

FIG. 6 is a diagram illustrating a physical configuration example of the information processing apparatus according to the example embodiment 1.

FIG. 7 is a flowchart illustrating one example of information processing according to the example embodiment 1.

FIG. 8 is a diagram illustrating one example of a target image according to the example embodiment 1.

FIG. 9 is a diagram illustrating a functional configuration example of an image processing unit according to an example embodiment 2.

FIG. 10 is a diagram illustrating a configuration example of a neural network according to the example embodiment 2.

FIG. 11 is a flowchart illustrating a detailed example of image processing according to the example embodiment 2.

FIG. 12 is a diagram illustrating one example of an iris area according to the example embodiment 2.

FIG. 13 is a diagram illustrating one example of a standard image according to the example embodiment 2.

FIG. 14 is a diagram illustrating a configuration example of a neural network according to an example embodiment 3.

FIG. 15 is a diagram illustrating a configuration example of an information processing system according to an example embodiment 4.

FIG. 16 is a flowchart illustrating one example of training processing according to the example embodiment 4.

FIG. 17 is a diagram illustrating one example of a training probability distribution according to the example embodiment 4.

FIG. 18 is a diagram illustrating a configuration example of an information processing system according to an example embodiment 5.

FIG. 19 is a flowchart illustrating one example of training processing according to the example embodiment 5.

FIG. 20 is a diagram illustrating one example of a selection probability distribution according to the example embodiment 5.

FIG. 21 is a diagram illustrating a configuration example of an information processing system according to an example embodiment 6.

FIG. 22 is a flowchart illustrating one example of training processing according to the example embodiment 6.

### EXAMPLE EMBODIMENT

Hereinafter, one example embodiment according to the present invention is described by using the drawings. Note that, in all drawings, a similar constituent element is indicated by a similar reference sign, and description thereof is omitted as necessary.

### Example Embodiment 1

### Overview

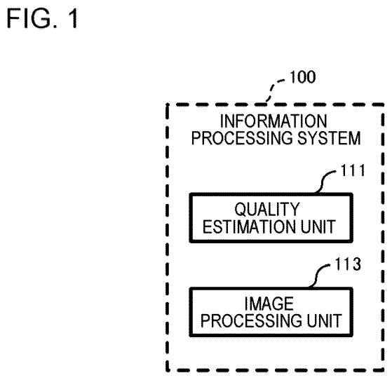

FIG. 1 is a diagram illustrating an overview of an information processing system 100 according to an example embodiment 1. The information processing system 100 includes a quality estimation unit 111 and an image processing unit 113.

The quality estimation unit 111 estimates quality information of a target image. The image processing unit 113 processes the target image by using a neural network according to a network policy to be decided based on quality information of the target image.

According to the information processing system 100, it becomes possible to perform recognition without depending on quality of a target image, while suppressing an increase in processing time.

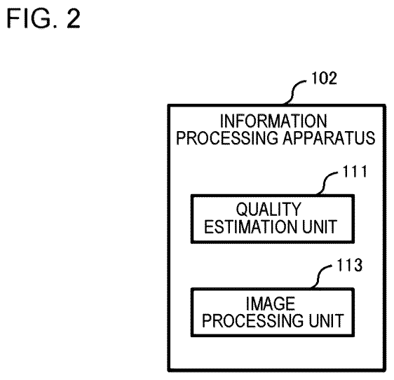

FIG. 2 is a diagram illustrating an overview of an information processing apparatus 102 according to the example embodiment 1. The information processing apparatus 102 includes the quality estimation unit 111 and the image processing unit 113.

The quality estimation unit 111 estimates quality information of a target image. The image processing unit 113 processes the target image by using a neural network according to a network policy to be decided based on quality information of the target image.

According to the information processing apparatus 102, it becomes possible to perform recognition without depending on quality of a target image, while suppressing an increase in processing time.

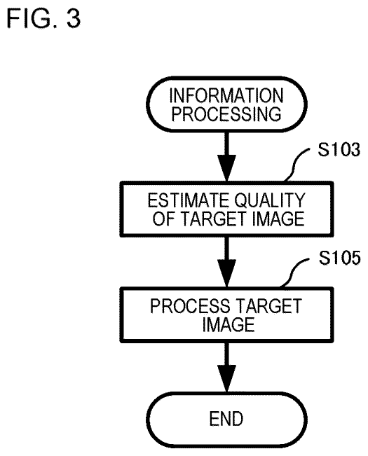

FIG. 3 is a flowchart illustrating an overview of information processing according to the example embodiment 1.

The quality estimation unit 111 estimates quality information of a target image (step S103).

The image processing unit 113 processes the target image by using a neural network according to a network policy to be decided based on quality information of the target image (step S105).

According to the information processing, it becomes possible to perform recognition without depending on quality of a target image, while suppressing an increase in processing time.

Hereinafter, a detailed example of the information processing system 100 according to the example embodiment 1 is described.

### Details

In the technique described in the above-described Patent Document 1, a so-called image super-resolution technique is used in order to improve a resolution. However, in image super-resolution, there is a problem that time for performing the processing gets long.

One example of an object of the present disclosure is, in view of these circumstances, to provide an information processing system, an information processing apparatus, an information processing method, and a medium that solve a task of performing recognition without depending on quality of a target image, while suppressing an increase in processing time.

### Configuration Example of Information Processing System 100 According to Example Embodiment 1

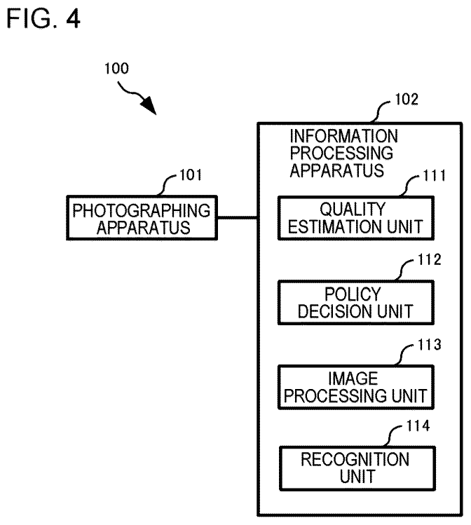

FIG. 4 is a diagram illustrating a configuration example of the information processing system 100 according to the example embodiment 1. The information processing system 100 is a system for performing processing by using a target image acquired by photographing a target. The present example embodiment is described by using an example in which processing using a target image is recognition processing for recognition a target.

The information processing system 100 includes a photographing apparatus 101, and the information processing apparatus 102.

The photographing apparatus 101 and the information processing apparatus 102 may be connected via a network configured by wired connection, wireless connection, or combining these, and mutually transmit and receive information via the network.

The target according to the present example embodiment is a person. Note that, the target is not limited thereto, and may be, for example, an animal such as a dog and a snake.

Further, in the recognition processing according to the present example embodiment, iris recognition is performed. The present example embodiment is described by using an example in which iris recognition is performed by using an image of a right iris. Note that, the recognition processing is not limited thereto, and, for example, recognition processing using an image, such as iris recognition using an image of a left iris, or a binocular iris, face recognition using a face image in which the entirety of a face is reflected, and vein recognition using an image in which a vein is reflected may be available.

The photographing apparatus 101 photographs a target, and generates a target image.

The target image is an image including a target area for use in recognition processing. In the present example embodiment, since iris recognition is performed by using an image as described above, the target area is an iris area in which an iris is reflected. More specifically, in the present example embodiment, since iris recognition is performed by using an image of a right iris, the target area is an iris area in which the right iris is reflected. Note that, iris recognition may be performed by using an image of a left iris, and the target area in this case may be an iris area in which the right iris is reflected.

### Functional Configuration Example of Information Processing Apparatus 102 According to Example Embodiment 1

The information processing apparatus 102 according to the present example embodiment performs recognition of a target reflected in a target image by using the target image generated by the photographing apparatus 101.

Note that, as will be described later, the present example embodiment is described by using an example in which the information processing apparatus 102 includes a recognition unit 114 that performs processing (recognition processing) of recognizing a target, however, the information processing apparatus 102 may perform processing for recognizing a target by using a target image, and recognition processing may be performed, for example, by another unillustrated information processing apparatus. In this case, the another information processing apparatus may include the recognition unit 114.

As illustrated in FIG. 4, the information processing apparatus 102 functionally includes, for example, the quality estimation unit 111, a policy decision unit 112, the image processing unit 113, and the recognition unit 114.

The quality estimation unit 111 estimates quality information of a target image.

The quality information is information indicating quality of a target image. The quality according to the present example embodiment is a resolution of the target image, and is, for example, a resolution of a target area included in the target image. Specifically, the quality according to the present example embodiment is a resolution of an iris area in which a right iris for use in recognition processing is reflected. In a case where the quality is a resolution, the quality is lowered, as the resolution decreases.

The quality estimation unit 111 may further estimate a target area position in a target image. The target area position is information for determining a position of the target area in the target image. In the present example embodiment, since the target area is the above-described iris area, the target area position according to the present example embodiment is a position of a right iris in the target image. Hereinafter, a position of a right iris in the target image is also referred to as an “eye position”.

The eye position includes, for example, a position of a pupil center, a pupil diameter, and an iris diameter. The pupil diameter is a diameter or a radius of a pupil. Further, the iris diameter is a diameter or a radius of an outer periphery of an iris. Using an eye position as described above enables to determine a position of a right iris in a target image.

Note that, the quality indicated by quality information is not limited to a resolution of a target image, and may be, for example, one or a plurality of a resolution of the target image, an iris diameter of an iris reflected in the target image, an estimated distance between the photographing apparatus 101 and a target, presence or absence of a blur or a degree thereof, and the like. The estimated distance may be estimated from information used in focus adjustment by the photographing apparatus 101, or may be estimated based on information from a distance sensor (not illustrated) for estimating a distance to a target. Further, the resolution of the target image is not limited to a target area, and may be, for example, a resolution or the like of a predetermined area included in the target image.

Further, the quality information may be represented, for example, by a vector quantity. In a case where the quality information is represented by a plurality of parameters, representing the quality information by using a vector quantity enables to handle the plurality of parameters, as a group of variables.

The policy decision unit 112 decides a network policy, based on quality information estimated by the quality estimation unit 111. The network policy is applied to a neural network for use in image processing by the image processing unit 113 to be described later.

The policy decision unit 112 may decide, for example, a network policy in which at least one of the following (A) and (B) is satisfied, regardless of quality information of a target image.

(A) is that processing time using a neural network lies within a predetermined range. (B) is that performance of recognition using a target image lies within a predetermined range.

The image processing unit 113 processes a target image by using a neural network according to a network policy decided by the policy decision unit 112. The image processing unit 113 according to the present example embodiment extracts, for example, features from a target image in processing of the target image.

Herein, for example, the image processing unit 113 may process a target image according to a network policy by using a neural network in which computation is performed by using detailed information, as quality (specifically, quality indicated by quality information) of the target image is lowered. In other words, the policy decision unit 112 decides a network policy in which computation is performed by using detailed information, as quality of a target image is lowered.

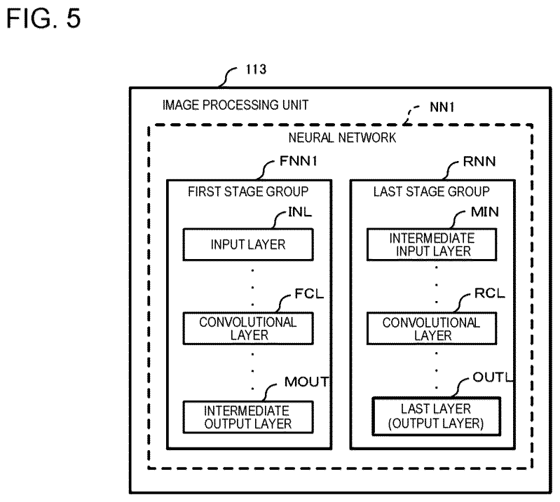

FIG. 5 is a diagram illustrating a configuration example of a neural network NN1 according to the example embodiment 1. The neural network NN1 is used in processing of a target image to be performed by the image processing unit 113. Herein, description is made by using an example in which the neural network NN1 is a convolutional neural network. Note that, the neural network NN1 is not limited thereto, and, for example, a vision transformer or the like may be adopted.

The neural network NN1 includes, for example, a plurality of layers. The plurality of layers included in the neural network NN1 are configured of a first stage group FNN1 including an input layer INL, and a last stage group RNN including a last layer OUTL.

The number of layers included in each of the first stage group FNN1 and the last stage group RNN may be changed as appropriate, however, the number of layers included in the first stage group FNN1 may be, for example, larger than the number of layers included in the last stage group RNN. Specifically, the first stage group FNN1 may be on an input side with respect to a layer located at a middle of a plurality of layers configuring the neural network NN1.

The first stage group FNN1 includes, for example, the input layer INL, at least one convolutional layer FCL, and an intermediate output layer MOUT. Note that, similarly to a general convolutional neural network, the first stage group FNN1 may include an unillustrated batch normalization layer, an activation function, and the like.

The input layer INL acquires an input image to the neural network NN1, and propagates the acquired input image, for example, to a succeeding layer. The input image is a target image. Note that, the image processing unit 113 may extract an image (e.g., an image of a target area) included in the target image, and use the extracted image, as an input image. Specifically, the input image may be an image to be acquired from the target image.

Each layer including the convolutional layer FCL processes the input image, and extracts, for example, features of the input image. The intermediate output layer MOUT outputs, as intermediate features, a processing result in the neural network NN1. Note that, the intermediate output layer MOUT may be a convolutional layer.

Herein, a network policy decided by the policy decision unit 112 is applied to image processing using the first stage group FNN1. In other words, the policy decision unit 112 decides a network policy to be applied to the first stage group FNN1. Specifically, for example, the policy decision unit 112 decides a network policy in which computation is performed by using detailed information, as quality of a target image is lowered.

At this occasion, the policy decision unit 112 may decide a network policy in which at least one of the above-described (A) and (B) is satisfied. For example, the policy decision unit 112 may hold in advance policy information in which a network policy according to quality of a target image is defined, acquire, from the policy information, the network policy according to quality of the target image, and thereby decide a network policy according to quality of the target image. In the policy information, for example, a network policy in which the first stage group FNN1 performs computation using detailed information according to quality of a target image may be defined in advance in such a way that at least one of the above-described (A) and (B) is satisfied.

The last stage group RNN includes, for example, an intermediate input layer MIN, at least one convolutional layer RCL, and the last layer (output layer) OUTL. Note that, similarly to a general convolutional neural network, the last stage group RNN may include an unillustrated batch normalization layer, an activation function, and the like.

The intermediate input layer MIN acquires intermediate features from the first stage group FNN1. Each layer including the convolutional layer RCL further processes the intermediate features, and extracts, for example, features of the input image. Note that, the intermediate input layer MIN may be a convolutional layer.

The last layer OUTL outputs a final processing result in the neural network NN1. The last layer OUTL outputs, for example, features based on a result of further processing in each layer including the convolutional layer RCL.

In this way, performing computation by using detailed information, as quality of a target image is lowered, enables to suppress lowering of performance of recognition to be performed in recognition processing, even in a low-quality target image. Meanwhile, since computation is performed by using detailed information, in the low-quality target image, processing time using a neural network increases, as compared with a high-quality target image.

As described above, for example, the policy decision unit 112 may decide a network policy in such a way that (A) processing time using a neural network lies within a predetermined range, regardless of quality information (specifically, quality indicated by quality information) of a target image. This enables to make processing time using a neural network substantially to a same degree, regardless of quality of a target image, while suppressing an increase in processing time (processing time using a neural network) in a case where the target image has low quality.

Further, for example, the policy decision unit 112 may decide a network policy in such a way that (B) performance of recognition using a target image lies within a predetermined range, regardless of quality information (specifically, quality indicated by quality information) of the target image. This enables to make performance of recognition to be performed in recognition processing substantially to a same degree, regardless of quality of a target image, while suppressing lowering of performance of recognition in a case where the target image has low quality.

The recognition unit 114 performs recognition processing by using a result of processing a target image by the image processing unit 113. The recognition processing is processing of recognizing a target by using a result of processing a target image.

For example, in a case where features extracted by the image processing unit 113 is acquired, the recognition unit 114 performs recognition of a target, based on whether the acquired features are registered in registration data. Although not illustrated, the recognition unit 114 may hold in advance the registration data.

So far, a functional configuration example of the information processing system 100 has been mainly described. Hereinafter, a physical configuration example of the information processing system 100 is described.

### Physical Configuration of Information Processing System 100

The information processing system 100 according to the present example embodiment is physically configured of, for example, the photographing apparatus 101, and the information processing apparatus 102. The photographing apparatus 101 is, for example, a camera such as a near infrared camera.

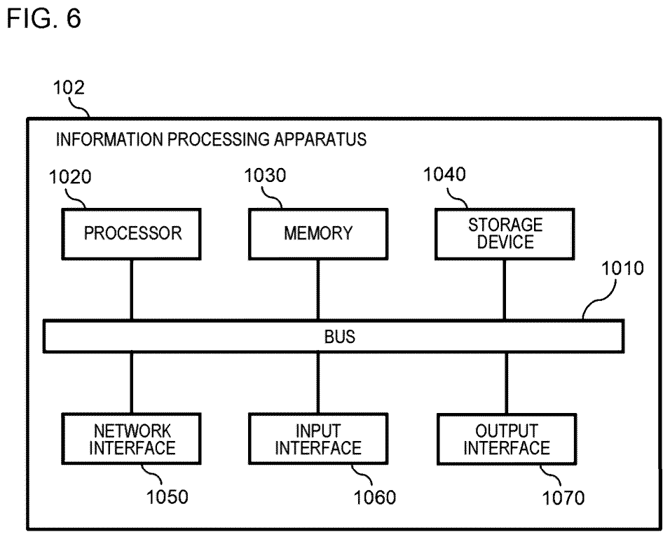

FIG. 6 is a diagram illustrating a physical configuration example of the information processing apparatus 102 according to the example embodiment 1. The information processing apparatus 102 includes a bus 1010, a processor 1020, a memory 1030, a storage device 1040, a network interface 1050, an input interface 1060, and an output interface 1070.

The bus 1010 is a data transmission path along which the processor 1020, the memory 1030, the storage device 1040, the network interface 1050, the input interface 1060, and the output interface 1070 mutually transmit and receive data. However, a method of mutually connecting the processor 1020 and the like is not limited to bus connection.

The processor 1020 is a processor to be achieved by a central processing unit (CPU), a graphics processing unit (GPU), or the like.

The memory 1030 is a main storage apparatus to be achieved by a random access memory (RAM) or the like.

The storage device 1040 is an auxiliary storage apparatus to be achieved by a hard disk drive (HDD), a solid state drive (SSD), a memory card, a read only memory (ROM), or the like. The storage device 1040 stores a program module for achieving a function of the information processing apparatus 102. A function associated with each program module is achieved by causing the processor 1020 to read the program module in the memory 1030 and execute the read program module.

The network interface 1050 is an interface for connecting the information processing apparatus 102 to a network.

The input interface 1060 is an interface for allowing a user to input information, and is configured of, for example a touch panel, a keyboard, a mouse, and the like.

The output interface 1070 is an interface for providing information to a user, and is configured of, for example, a liquid crystal panel, an organic electro-luminescence (EL) panel, or the like.

Note that, a function of the information processing apparatus 102 may be physically achieved by using a plurality of information processing apparatuses. Each of the information processing apparatuses in this case may be physically configured, for example, similarly to the information processing apparatus 102 illustrated in FIG. 6. Further, the plurality of information processing apparatuses may be connected via a network configured by wired connection, wireless connection, or combining these, and may be configured in such a way as to mutually transmit and receive information via the network.

So far, the configuration example of the information processing system 100 according to the example embodiment 1 has been described. Hereinafter, an operation example of the information processing system 100 according to the example embodiment 1 is described.

### Operation Example of Information Processing System 100 According to Example Embodiment 1

The information processing system 100 performs information processing. The information processing according to the present example embodiment is processing of recognizing a target reflected in a target image by using the target image acquired by photographing the target.

Note that, the present example embodiment is described by using an example in which the information processing includes recognition processing of recognizing a target, however, the information processing may be processing for recognizing a target by using a target image, and may not include recognition processing.

The information processing may be started, for example, by accepting a signal from an unillustrated sensor. The sensor is, for example, a sensor detecting that a person is present or has entered an area to be photographed by the photographing apparatus 101. Note that, a method of starting the information processing is not limited thereto.

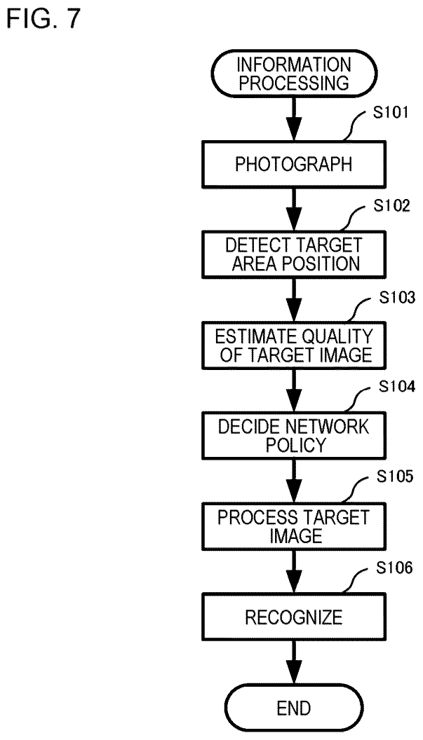

FIG. 7 is a flowchart illustrating one example of the information processing according to the example embodiment 1.

The photographing apparatus 101 photographs a target (step S101). Thus, the photographing apparatus 101 generates a target image in which the target is reflected.

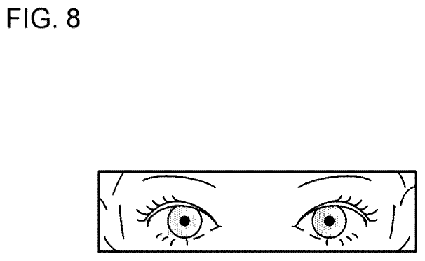

FIG. 8 is a diagram illustrating one example of a target image according to the example embodiment 1. The target image according to the present example embodiment is an eye image including both eyes of a target. The eye image is one example of an image including a target area according to the present example embodiment. The target area according to the present example embodiment is an iris area in which a right iris is reflected as described above.

Note that, the target image may be changed in various ways according to a kind of recognition to be performed by using the target image. For example, in a case where face recognition is performed, the target image may be a face image including a face of a target and a background, an image including an upper body or the entire body of the target, or the like. The target area in this case is a target area a face area in which a face is reflected. For example, in a case where vein recognition is performed, the target image may be an image including, as a target area, an area where a vein is reflected.

Further, for example, a target image in a case for use in iris recognition is not limited to an eye image, and may be a face image, an image including an upper body or the entire body of a target, or the like. Further, the eye image is not limited to an eye image including both eyes of a target, and may be a monocular image including a predetermined eye between left and right eyes of the target, or the like. The eye image illustrated in FIG. 6 includes not only an iris but also a pupil, a white portion of an eye, an eyelid, eyelashes, and the like, however, the eye image may include at least an iris area for use in recognition processing, and may not include one or a plurality of a pupil, a white portion of an eye, an eyelid, eyelashes, and the like.

FIG. 7 is referred to again.

The quality estimation unit 111 estimates a target area position in the target image (step S102).

The quality estimation unit 111 according to the present example embodiment estimates, from a target image, for example, an eye position including a position of a pupil center of a right eye, a pupil diameter, and an iris diameter.

As a technique for estimating the eye position by the quality estimation unit 111, a general technique such as pattern matching or a machine learning model may be used. In a case where a machine learning model is used, the quality estimation unit 111 may estimate the eye position in the target image by using a learning model in which training for estimating the eye position from the target image is performed, and setting the target image, as an input. In training of the learning model, supervised training in which training data including the eye position of the target image are used may be performed by setting a training target image, as an input.

The quality estimation unit 111 estimates quality of the target image (step S103). Thus, the quality estimation unit 111 generates quality information including quality of the target image.

The quality estimation unit 111 according to the present example embodiment determines, for example, an iris area (specifically, an area in which a right iris of a target is reflected) included in the target image, based on the eye position estimated in step S102. The iris area is a ring-shaped area surrounded by concentric circles with a diameter according to each of a pupil diameter and an iris diameter with respect to a pupil center, substantially as a center. Note that, as illustrated in FIG. 8, in a case where a part of the iris area is covered by an eyelid or the like, the iris area has a shape devoid of a part covered by the eyelid or the like from the ring-shaped area.

The quality estimation unit 111 derives a resolution of the determined iris area. The resolution is, for example, an image size. In this case, the quality estimation unit 111 derives an image size of the determined iris area. The image size of the iris area is a pixel number of the iris area.

Alternatively, the quality estimation unit 111 may derive quality of the target image by using a learning model. The learning model in this case may estimate quality of the target image by using a learning model in which training for estimating quality of the target image is performed, and setting the target image, as an input. Further, in training of the learning model, supervised training in which training data including quality of the target image are used may be performed by setting a training target image, as an input.

Note that, an iris diameter may be adopted as the image size. In this case, step S102 includes processing of estimating quality of the target image. Further, even in a case where a value other than the iris diameter is used as quality of the target image, a common learning model between steps S102 and S103 may be used. The learning model in this case may estimate the eye position in the target image, and quality of the target image by using a learning model in which training for estimating, from the target image, the eye position and quality of the target image is performed, and setting the target image, as an input. Further, in training of the learning model, supervised training in which training data including the eye position and quality of the target image are used from the target image may be performed by setting a training target image, as an input.

The policy decision unit 112 decides a network policy, based on quality of the target image estimated in step S103 (step S104).

Specifically, for example, a network policy may be decided in such a way that at least one of the above-described (A) and (B) is satisfied, regardless of quality information of the target image.

The image processing unit 113 processes the target image by using the neural network NN1 according to the network policy decided in step S104 (step S105).

Specifically, for example, the image processing unit 113 extracts, from the iris area estimated in step S102, features of the iris area, by using the neural network NN1 according to the network policy.

Herein, for example, it is assumed that, in step S104, the policy decision unit 112 decides a network policy in which both of (A) and (B) are satisfied, regardless of quality information of the target image. This enables to make both of time for processing (specifically, for example, processing for extracting features) using the neural network NN1, and performance of recognition to be performed in recognition processing to a substantially same degree, regardless of quality of the target image.

The recognition unit 114 performs recognition processing by using a result of processing in step S105 (step S106).

Specifically, for example, the recognition unit 114 acquires features extracted by the image processing unit 113. The recognition unit 114 compares the acquired features with features to be acquired from registration data being held in advance, and recognizes a target, based on a result of the comparison.

More specifically, for example, the recognition unit 114 derives similarity between acquired features, and features to be acquired from registration data. The recognition unit 114 recognizes a target, based on a result of comparison between the similarity and a predetermined threshold value. For example, in a case where the similarity is equal to or more than the threshold value, the recognition unit 114 decides that recognition of a target is successful. Further, for example, in a case where the similarity is less than the threshold value, the recognition unit 114 decides that recognition of a target has failed. Note that, the recognition method is not limited thereto, and a general method may be used.

### Advantageous Effect

As described above, according to the present example embodiment, the information processing system 100 includes the quality estimation unit 111, and the image processing unit 113.

The quality estimation unit 111 estimates quality information of a target image. The image processing unit 113 processes the target image by using the neural network NN1 according to a network policy to be decided based on quality information of the target image.

This enables to change processing in the neural network NN1 according to quality of a target image. Therefore, it becomes possible to perform recognition without depending on quality of a target image, while suppressing an increase in processing time.

According to the present example embodiment, the image processing unit 113 extracts features from a target image by using the neural network NN1 according to a network policy.

This enables to perform recognition processing by using features. Processing for extracting features are performed by using the neural network NN1 according to a network policy. Therefore, it becomes possible to perform recognition without depending on quality of a target image, while suppressing an increase in processing time.

According to the present example embodiment, a target image is an eye image including an iris area in which an iris is reflected. Quality information includes an iris diameter.

This enables to change processing in the neural network NN1 according to an iris diameter of a target image. Therefore, it becomes possible to perform recognition such as iris recognition without depending on quality of a target image, while suppressing an increase in processing time.

According to the present example embodiment, quality information includes a resolution of a target image.

This enables to change processing in the neural network NN1 according to a resolution of a target image. Therefore, it becomes possible to perform recognition without depending on quality of a target image, while suppressing an increase in processing time.

According to the present example embodiment, the information processing system 100 further includes the policy decision unit 112 that decides a network policy, based on quality information.

This enables to decide a network policy according to quality of a target image. Further, processing in the neural network NN1 can be changed according to the decided network policy. Therefore, it becomes possible to perform recognition without depending on quality of a target image, while suppressing an increase in processing time.

According to the present example embodiment, the policy decision unit 112 decides a network policy in such a way that processing time using the neural network NN1 lies within a predetermined range, regardless of a resolution of a target image.

This enables to suppress an increase in processing time accompanied by a change in the processing, while changing the processing in the neural network NN1 according to a resolution of a target image. Therefore, it becomes possible to perform recognition without depending on quality of a target image, while suppressing an increase in processing time.

According to the present example embodiment, the neural network NN1 is configured of the first stage group FNN2 including the input layer INL, and the last stage group RNN including the last layer OUTL. A network policy is applied to image processing using the first stage group FNN2.

This enables to change processing in the neural network NN1 according to a resolution of a target image. Further, an increase in processing time can be suppressed, as compared with a case where quality of an input image to be input to the neural network NN1 is improved by using an image super-resolution technique or the like. Therefore, it becomes possible to perform recognition without depending on quality of a target image, while suppressing an increase in processing time.

### Example Embodiment 2

In the present example embodiment, a detailed example of a network policy and processing to be performed by an image processing unit 113 is described. In the present example embodiment, to simplify description, description overlapping the above-described example embodiment is omitted as appropriate.

An information processing system according to the present example embodiment may be configured substantially similarly to the information processing system 100 according to the example embodiment 1 illustrated in FIGS. 4 and 6. Specifically, for example, similarly to the example embodiment 1, the image processing unit 113 processes a target image by using a neural network according to a network policy. Further, for example, similarly to the example embodiment 1, a neural network configuring the image processing unit 113 performs computation according to a network policy by using detailed information, as quality of a target image is lowered.

The image processing unit 113 according to the present example embodiment converts an iris area included in a target image into a standard image of a predetermined shape, and processes the converted standard image, as an input image to a neural network.

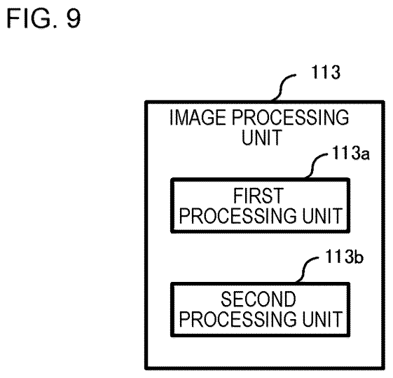

FIG. 9 is a diagram illustrating a functional configuration example of the image processing unit 113 according to an example embodiment 2. The image processing unit 113 includes a first processing unit 113a, and a second processing unit 113b.

The first processing unit 113a converts a target area (specifically, for example, an iris area) included in a target image into a standard image of a predetermined shape. Specifically, for example, the first processing unit 113a extracts an iris area from a target image, and converts the extracted iris area into a standard image of a predetermined shape. This allows the first processing unit 113a to generate a standard image, based on a target image.

The second processing unit 113b processes the standard image acquired by the first processing unit 113a by using a neural network according to a network policy decided by a policy decision unit 112. The second processing unit 113b according to the present example embodiment extracts, for example, features from a standard image in standard image processing.

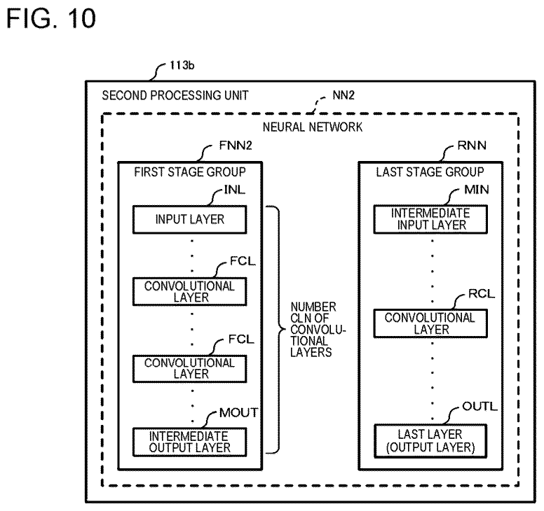

FIG. 10 is a diagram illustrating a configuration example of a neural network NN2 according to the example embodiment 2. The neural network NN2 is used in standard image processing to be performed by the second processing unit 113b according to the example embodiment 2. The present example embodiment is also described by using an example in which the neural network NN2 is a convolutional neural network.

Similarly to the example embodiment 1, for example, the neural network NN2 includes a plurality of layers. The plurality of layers included in the neural network NN2 are configured of a first stage group FNN2 including an input layer INL, and a last stage group RNN similar to that of the example embodiment 1.

The first stage group FNN2 includes the input layer INL, CLN pieces of convolutional layers FCL, and an intermediate output layer MOUT.

Similarly to the example embodiment 1, the input layer INL acquires an input image, and propagates the acquired input image, for example, to a succeeding layer. The input image according to the present example embodiment is a standard image to be generated by the first processing unit 113a.

Each layer including the CLN pieces of convolutional layers FCL processes the input image, and extracts, for example, features of the input image. The intermediate output layer MOUT outputs, as intermediate features, a processing result in the neural network NN2. Note that, the intermediate output layer MOUT may be a convolutional layer.

Also in the present example embodiment, a network policy decided by the policy decision unit 112 is applied to image processing using the first stage group FNN2.

Specifically, for example, the policy decision unit 112 according to the present example embodiment decides a network policy in such a way that the number CLN of convolutional layers FCL included in the first stage group FNN2 increases, as a resolution of a target image is lowered. The network policy is one example of a network policy in which the first stage group FNN2 performs computation by using detailed information, as quality of a target image is lowered.

The information processing according to the present example embodiment may be configured substantially similarly to the information processing according to the example embodiment 1 illustrated in FIG. 7. Specifically, for example, in step S105, the image processing unit 113 processes a target image by using a neural network according to a network policy to be decided based on quality information of the target image.

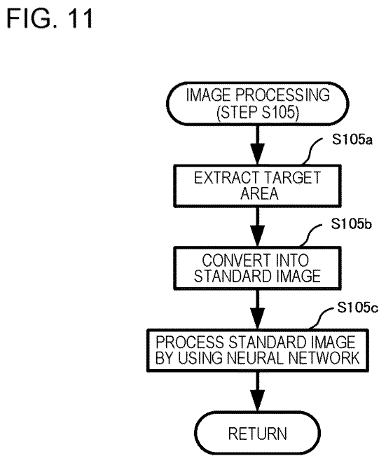

FIG. 11 is a flowchart illustrating a detailed example of image processing (step S105) according to the example embodiment 2. Note that, in the image processing (step S105), as described with reference to FIG. 7, the image processing unit 113 may process a target image by using a neural network according to a network policy decided in step S104.

The first processing unit 113a extracts a target area from the target image (step S105a).

Specifically, for example, the target area is an iris area. Therefore, the first processing unit 113a extracts a substantially ring-shaped iris area.

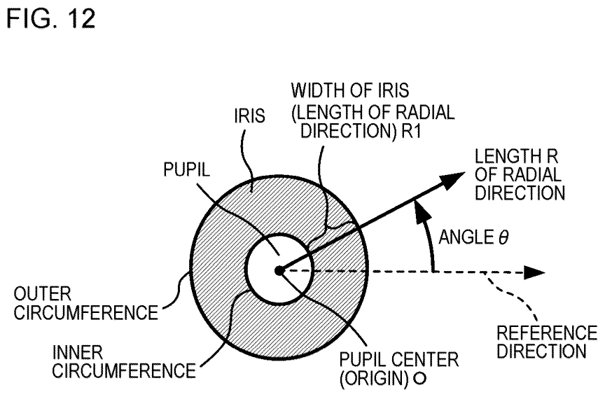

FIG. 12 is a diagram illustrating one example of the iris area according to the example embodiment 2. In FIG. 12, the iris area is a hatched area, and is surrounded by an inner circumference and an outer circumference being concentric circles with respect to a pupil center O as a center. The inner circumference is a circumference according to a pupil diameter. The outer circumference is a circumference according to an iris diameter. An iris area as described above can be represented, for example, by a polar coordinate system in which the pupil center O is set as an origin, and a length R in a radial direction and an angle θ with respect to a predetermined reference direction are used. Note that, an inner portion of the inner circumference is an area associated with a pupil, however, the area may not be included in the iris area.

FIG. 11 is referred to again.

The first processing unit 113a converts the target area extracted in step S105a into a standard image of a predetermined shape (step S105b). Thus, the first processing unit 113a generates a standard image.

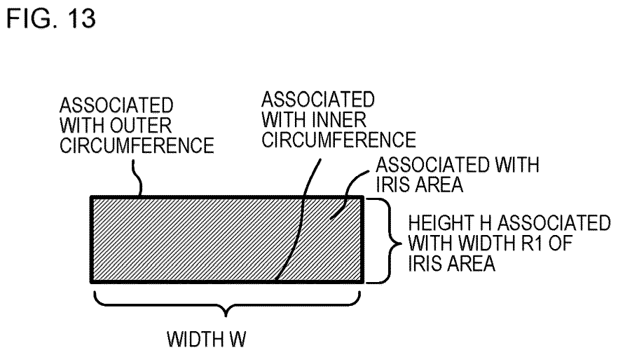

FIG. 13 is a diagram illustrating one example of the standard image according to the example embodiment 2. FIG. 13 illustrates an example in which the predetermined shape is a rectangle, however, the predetermined shape is not limited thereto.

In a case where a ring-shaped iris area illustrated in FIG. 12 is converted into a rectangular standard image illustrated in FIG. 13, for example, a height H of the standard image is associated with a width R1 of the ring-shaped iris area. Further, for example, a width W of the standard image is associated with an outer side and an inner side of the ring-shaped iris area.

In step S105b, the first processing unit 113a may convert the iris area into the standard image of a size according to quality information (e.g., a resolution) of the iris area. Specifically, the size of the standard image may differ according to quality (e.g., an image size of an iris area) of a target image. In this case, the first processing unit 113a may convert the target area into the standard image of a larger size, as quality of the target image increases (e.g., as an image size of the iris area increases). Further, in a case where the standard image is a rectangle, an aspect ratio of the standard image may be fixed.

As a method of converting a ring-shaped iris area into a rectangular standard image, an appropriate method may be adopted.

For example, the first processing unit 113a may convert the target area into the standard image of a discretely different size according to quality of the target image. In this case, for example, the first processing unit 113a may hold in advance conversion pattern data indicating a size of a plurality of standard images according to quality of the target image. Further, the first processing unit 113a may acquire, from the conversion pattern data, a size of the standard image associated with quality of the target area estimated in step S103, and convert the target area extracted in step S105a into the standard image of the acquired size. Conversion as described above may be performed as appropriate by using conversion from a polar coordinate system into a rectangular coordinate system, conversion of enlarging and reducing an image, and the like.

Further, for example, the first processing unit 113a may convert the target area into the standard image of a continuously different size according to quality of the target image. In this case, for example, the first processing unit 113a may convert the iris area extracted in step S105a into a rectangular image by using conversion from a polar coordinate system into a rectangular coordinate system. Further, in a case where an aspect ratio of the rectangular image is different from an aspect ratio of a predetermined standard image, the first processing unit 113a may convert the rectangular image into the standard image of the predetermined aspect ratio by using at least one of conversion of enlarging and reducing an image.

At this occasion, to which extent and in which direction being a vertical direction or a horizontal direction, conversion is made in order to convert the aspect ratio of the rectangular image into the predetermined aspect ratio of the standard image may be decided according to a predetermined conversion condition.

For example, in a case where the conversion condition is not converting the horizontal direction, the first processing unit 113a may convert the rectangular image into a standard image being a rectangle of the predetermined aspect ratio by enlarging or reducing the rectangular image in the vertical direction. Further, in a case where the conversion condition is not converting the vertical direction, the first processing unit 113a may convert the rectangular image into a standard image being a rectangle of the predetermined aspect ratio by enlarging or reducing the rectangular image in the horizontal direction. Note that, the conversion condition is not limited thereto.

Converting as described above enables to convert an iris area into a standard image of a size according to quality information (e.g., a resolution) of the iris area. Further, the standard image becomes an image of quality (e.g., a resolution) associated with quality information of the iris area.

FIG. 11 is referred to again.

The second processing unit 113b processes the standard image generated in step S105b by using the neural network NN2 according to the network policy decided in step S104 (step S105c). Then, the second processing unit 113b may return to the information processing illustrated in FIG. 7.

Specifically, for example, as described above, a size of a standard image discretely or continuously differs according to quality of a target image. An example of a network policy is described regarding each of the cases.

### Example of Network Policy in Case Where Size of Standard Image Discretely Differs

For example, it is assumed that quality of a target image is a resolution of an input image. Further, in a case where the resolution of the input image is a predetermined reference resolution, it is assumed that the number CLN of convolutional layers FCL for use in computation in the first stage group FNN2 is a reference value RFN1.

In this case, the policy decision unit 112 may decide a network policy in which the number CLN of convolutional layers FCL for use in computation in the first stage group FNN is increased to RFN1*N*N, in a case where the resolution of the input image becomes 1/N with respect to the reference resolution. Each of N and RFN1 is an integer of 1 or more. Further, “*” represents multiplication.

Thus, the second processing unit 113b processes the input image, and outputs intermediate features by using the first stage group FNN2 including the number CLN convolutional layers FCL according to the network policy.

Note that, the network policy is not limited thereto, and, for example, to which extent detailed information is used to perform computation according to quality of a target image may be changed as appropriate.

### Example of Network Policy in Case Where Size of Standard Image Continuously Differs

For example, similarly to a case where a size discretely differs, it is assumed that quality of a target image is a resolution of an input image. Further, in a case where the resolution of the input image is a predetermined reference resolution, it is assumed that the number CLN of convolutional layers FCL for use in computation in the first stage group FNN2 is the reference value RFN1.

In this case, the policy decision unit 112 may decide a network policy in which the number CLN of convolutional layers FCL for use in computation in the first stage group FNN is increased to [RFN1*α*α], in a case where the resolution of the input image becomes 1/α with respect to the reference resolution. Herein, α is a real number, and, for example, satisfies 0<α≤1. Further, a symbol [X] is a Gaussian function (also referred to as a floor function), and represents a maximum integer not exceeding the real number X within the symbol. Specifically, [RFN1*α*α] represents a maximum integer not exceeding RFN1*α*α.

Thus, the second processing unit 113b processes the input image, and outputs intermediate features by using the first stage group FNN2 including the number CLN convolutional layers FCL according to the network policy. Note that, the network policy is not limited thereto, and, for example, to which extent detailed information is used to perform computation according to quality of a target image may be changed as appropriate, similarly to a case where a size of a standard image discretely differs.

Further, in a case where a size of a standard image continuously differs, a map shape of intermediate features may be adjusted in the first stage group FNN2 in such a way that the intermediate features becomes a shape (specifically, a size) of a feature map being able to be input to the last stage group RNN.

For example, as a method of adjusting a map shape of intermediate features, interpolation can be used. For example, it is assumed that convolutional computation of a slide S and a padding PD is performed by using a 3×3 filter, and a shape of a feature map to be input to the filter is (Hin, Win). In a case where a shape of a feature map to be output by the convolutional computation is (Hout, Wout), the feature map to be input may be adjusted by using interpolation in such a way that a relationship: Hin=S*(Hout−1)+3−2*PD, Win=S*(out−1)+3−2*PD is satisfied. For interpolation, a nearest neighbor method, linear interpolation, a bilinear method, a bicubic method, and the like may be used. Interpolation as described above may be performed, for example, prior to a first convolutional layer FCL (specifically, a convolutional layer FCL nearest to an input) included in the first stage group FNN2.

Further, for example, as a method of adjusting a map shape of intermediate features, it is possible to use a value of a dialation parameter for use in a convolutional layer FCL. The dialation parameter is a parameter for adjusting an interval of values on a map in which a product of a filter for use in the convolutional layer FCL is performed.

Note that, a method of adjusting a map shape of intermediate features is not limited thereto.

### Advantageous Effect

As described above, according to the present example embodiment, the image processing unit 113 includes the first processing unit 113a, and the second processing unit 113b.

The first processing unit 113a converts an iris area included in a target image into a standard image of a predetermined shape. The second processing unit 113b processes the standard image by using the neural network NN2 according to a network policy. The first processing unit 113a converts the iris area into a standard image of a size according to quality information.

Thus, since a shape of an input image to the neural network NN2 can be standardized into a predetermined shape, processing in the neural network NN2 can be performed easily, as compared with a case where the shape of the input image is irregular.

Further, since an image associated with an iris area can be used as an input image, features of the iris area can be extracted with high performance, and thereby performance of iris recognition can be improved.

Furthermore, generally, in a case where a resolution of an image is improved by using an image super-resolution technique or the like, since a high-resolution image is processed in a neural network, it is often a case that processing time in the neural network gets long. In the present example embodiment, since a standard image has a size according to a resolution, an increase in processing time in the neural network NN2 can be suppressed, as compared with a case where a high-resolution image is uniformly processed in the neural network NN2.

Therefore, it becomes possible to perform high-performance recognition without depending on quality of a target image, while suppressing an increase in processing time.

According to the present example embodiment, the neural network NN2 includes a plurality of convolutional layers FCL, and an RCL. The policy decision unit 112 decides a network policy in such a way that the number CLN of convolutional layers FCL included in the first stage group FNN2 increases, as a resolution of a target image is lowered.

This enables to perform computation using detailed information, since a larger number of convolutional layers FCL can be used, as quality of a target image is lowered. Therefore, an input image can be processed in the neural network NN2 in such a way as to perform high-performance recognition without depending on quality of the input image. Further, an increase in processing time can be suppressed, as compared with a case where quality of an input image to be input to the neural network NN2 is improved by using an image super-resolution technique or the like.

Therefore, it becomes possible to perform recognition without depending on quality of a target image, while suppressing an increase in processing time.

### Example Embodiment 3

In the example embodiment 2, an example in which computation is performed by using detailed information, as quality of a target image is lowered, by increasing a number CLN of convolutional layers FCL, as a resolution of the target image is lowered, has been described. In an example embodiment 3, as another example in which computation is performed by using detailed information, as a resolution of a target image is lowered, an example in which a channel number in computation in a convolutional layer FCL is increased, as a resolution of a target image is lowered, is described. In the present example embodiment, to simplify description, description overlapping the above-described example embodiments is omitted as appropriate.

In the present example embodiment, a configuration of a neural network for use in processing of a standard image to be performed by a second processing unit 113b is different from that of the example embodiment 2. Except for this point, an information processing system according to the present example embodiment may be configured substantially similarly to the information processing system according to the example embodiment 2.

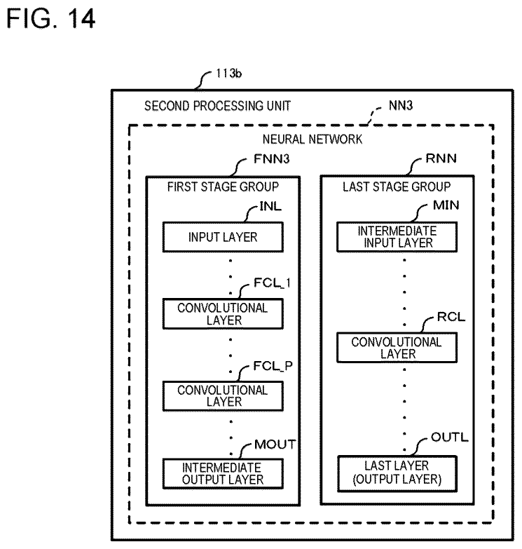

FIG. 14 is a diagram illustrating a configuration example of a neural network NN3 according to the example embodiment 3. The neural network NN3 is used in processing of a standard image to be performed by the second processing unit 113b according to the example embodiment 3. The present example embodiment is also described by using an example in which the neural network NN3 is a convolutional neural network.

Similarly to the example embodiment 1, for example, the neural network NN3 includes a plurality of layers. The plurality of layers included in the neural network NN3 are configured of a first stage group FNN2 including an input layer INL, and a last stage group RNN similar to that of the example embodiment 1.

The first stage group FNN3 includes the input layer INL similar to that of the example embodiment 1, P pieces of convolutional layers FCL_1 to FCL_P, and an intermediate output layer MOUT. Herein, P is an integer of 2 or more.

The channel number is different among the convolutional layers FCL_1 to FCL_P. The channel number is, for example, equivalent to the number of filters for use in each of the convolutional layers FCL_1 to FCL_P. Each layer including any one of the convolutional layers FCL_1 to FCL_P processes an input image, and extracts, for example, features of the input image. Note that, the present example embodiment is described by using an example in which a convolutional layer FCL whose channel number is the same is one, however, the first stage group FNN3 may include a plurality of convolutional layers FCL whose channel number is the same.

The intermediate output layer MOUT outputs, as intermediate features, a processing result in the neural network NN2.

In the present example embodiment, since the channel number of the convolutional layers FCL_1 to FCL_P is different from one another, a shape of a feature map to be output from each of the convolutional layers FCL_1 to FCL_P is different from one another. Also in a case where any of the convolutional layers FCL_1 to FCL_P is used, the intermediate output layer MOUT may adjust a size (a shape of a feature map indicating intermediate features) of intermediate features in such a way that the intermediate feature can be input to the last stage group RNN. For the adjustment, for example, 1×1 convolition or the like may be used.

Also in the present example embodiment, a network policy decided by a policy decision unit 112 is applied to image processing using the first stage group FNN3.

Specifically, for example, the policy decision unit 112 according to the present example embodiment decides a network policy in such a way that a convolutional layer FCL whose channel number is larger is used in the first stage group FNN2, as a resolution of a target image is lowered. The network policy is one example of a network policy in which the first stage group FNN3 performs computation by using detailed information, as quality of a target image is lowered.

Information processing according to the present example embodiment may be configured substantially similarly to the information processing according to the example embodiment 1 illustrated in FIG. 7. Further, details of image processing (step S105) according to the present example embodiment may be configured substantially similarly to the image processing (step S105) according to the example embodiment 2 illustrated in FIG. 11.

Specifically, for example, in step S105c, the second processing unit 113b processes a standard image generated in step S105b by using the neural network NN3 according to a network policy decided in step S104.

For example, it is assumed that a size of a standard image discretely differs, and quality of a target image is a resolution of an input image. Further, in a case where the resolution of the input image is a predetermined reference resolution, it is assumed that the channel number of convolutional layers FCL1 to FCL_P for use in computation in the first stage group FNN2 is a reference number RFN2. Herein, RFN2 is an integer of 1 or more.

In this case, the policy decision unit 112 may decide a network policy in which the channel number of the convolutional layers FCL_1 to FCL_P for use in computation in the first stage group FNN is increased to RFN2*N*N, in a case where the resolution of the input image becomes 1/N with respect to the reference resolution.

Thus, the second processing unit 113b processes the input image, and outputs intermediate features by using the first stage group FNN3 including a convolutional layer FCL with the channel number according to the network policy among the convolutional layers FCL_1 to FCL_P. Note that, the network policy is not limited thereto, and, for example, to which extent detailed information is used to perform computation according to quality of a target image may be changed as appropriate.

For example, in a case where a size of a standard image continuously differs, a network policy in which the channel number of the convolutional layers FCL_1 to FCL_P for use in computation in the first stage group FNN is increased to [RFN2*α*α], in a case where the resolution of the input image becomes 1/α with respect to the reference resolution may be decided. The symbol [ ] herein is a Gaussian function similar to that described above. Specifically, [RFN2*α*α] represents a maximum integer not exceeding RFN2*α*α.

Note that, the network policy is not limited thereto, and, for example, to which extent detailed information is used to perform computation according to quality of a target image may be changed as appropriate, similarly to a case where a size of a standard image discretely differs.

Further, similarly to the example embodiment 2, in a case where a size of a standard image continuously differs, in the first stage group FNN3, a map shape of intermediate features may be adjusted in such a way that the intermediate features can be input to the last stage group RNN.

### Advantageous Effect

As described above, according to the present example embodiment, the neural network NN3 includes the plurality of convolutional layers FCL_1 to FCL_P, and an RCL. The policy decision unit 112 decides a network policy in such a way that the channel number in computation on the convolutional layers FCL_1 to FCL_P included in the first stage group FNN3 is increased, a target image is lowered.

In this way, since the convolutional layers FCL_1 to FCL_P whose channel number is larger can be used, as quality of a target image is lowered, computation using detailed information can be performed. Therefore, an input image can be processed in the neural network NN3 in such a way as to be able to perform high-performance recognition without depending on quality of the input image. Further, an increase in processing time can be suppressed, as compared with a case where quality of an input image to be input to the neural network NN3 is improved by using an image super-resolution technique or the like.

Therefore, it becomes possible to perform recognition without depending on quality of a target image, while suppressing an increase in processing time.

### Example Embodiment 4

In an example embodiment 4, an example of a training method of neural networks NN1 to NN3 is described. In the present example embodiment, a training method of the neural network NN1 according to the example embodiment 1 is described as an example. Further, in the present example embodiment, to simplify description, description overlapping the above-described example embodiments is omitted as appropriate.

### Configuration Example of Information Processing System 400 According to Example Embodiment 4

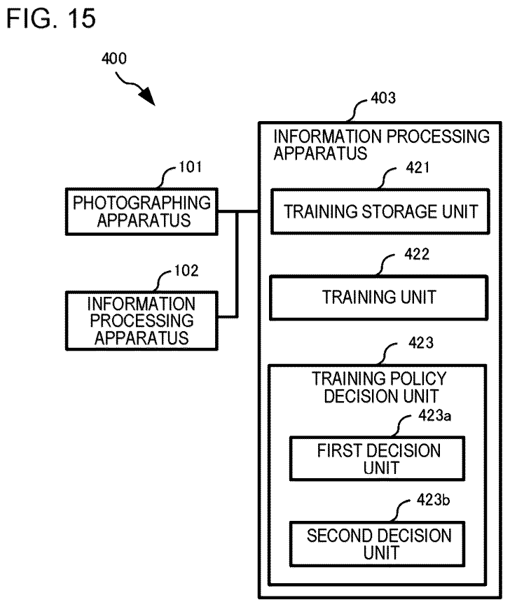

FIG. 15 is a diagram illustrating a configuration example of an information processing system 400 according to the example embodiment 4. The information processing system 400 includes an information processing apparatus 403, in addition to a photographing apparatus 101 and an information processing apparatus 102 similar to those of the example embodiment 1.

The information processing apparatus 403 is an apparatus for performing training of the neural network NN1. The information processing apparatus 403 includes a training storage unit 421, a training unit 422, and a training policy decision unit 423.

The training storage unit 421 is a storage unit for storing in advance training data. The training data include a training target image and a correct answer value. For example, in a case where features of a target image is extracted by using the neural network NN1, the correct answer value is features of a training target image.

The training target image is an image for training. Similarly to a target image, the training target image may be an image including a target area, and is, for example, an eye image.

Note that, the training storage unit 421 may store in advance training data including a plurality of different training target images. In this case, the plurality of training target images may desirably include a training target image whose quality is different.

The training unit 422 performs training of the neural network NN1 by inputting a training target image to the neural network NN1.

The training policy decision unit 423 decides, based on quality information of a training target image, and a training probability distribution, a network policy regarding the training target image.

Specifically, for example, the training policy decision unit 423 includes a first decision unit 423a, and a second decision unit 423b.

The first decision unit 423a changes quality information of a training target image according to a training probability distribution by using a random number, and decides training quality information.

More specifically, for example, the first decision unit 423a may include a function similar to that of a quality estimation unit 111. Specifically, the first decision unit 423a may estimate a target area position in a training target image, and estimate quality of the training target image.

Then, the first decision unit 423a changes the estimated quality regarding the training target image according to the training probability distribution by using the random number, and decides training quality information. The training probability distribution is, for example, a probability distribution in which a probability becomes highest at quality indicated by quality information of a training target image, and a probability is gradually lowered, as a degree different from the quality increases.

The second decision unit 423b decides a network policy regarding a training target image according to training quality information decided by the first decision unit 423a.

The information processing apparatus 403 may be physically configured similarly to the information processing apparatus 102 (see FIG. 6). However, a storage device 1040 of the information processing apparatus 403 stores a program module for achieving a function of the information processing apparatus 403. Further, a network interface 1050 of the information processing apparatus 403 is an interface for connecting the information processing apparatus 403 to a network.

### Operation Example of Information Processing System 400 According to Example Embodiment 4

The information processing system 400 performs information processing. The information processing according to the present example embodiment includes training processing, in addition to processing similar to that of the example embodiment 1. For example, the training processing is processing for performing training of the neural network NN1. For example, the information processing apparatus 403 starts training processing upon accepting an instruction of a user.

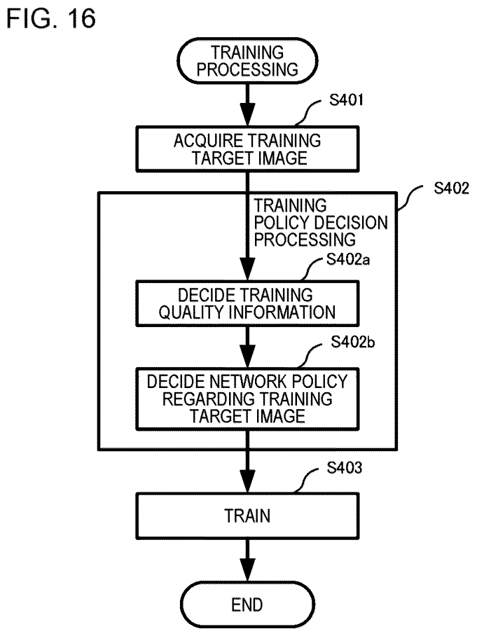

FIG. 16 is a flowchart illustrating one example of training processing according to the example embodiment 4.

The training policy decision unit 423 acquires a training target image from the training storage unit 421 (step S401).

Note that, the training policy decision unit 423 may acquire a training target image from another information processing apparatus (not illustrated) via a network or the like, or may acquire a training target image via a medium.

The training policy decision unit 423 decides, based on quality information of the training target image, and a training probability distribution, a network policy regarding the training target image acquired in step S401 (step S402).

Specifically, for example, the first decision unit 423a changes quality information of the training target image according to the training probability distribution, and decides training quality information (step S402a).

More specifically, for example, the first decision unit 423a estimates quality of the training target image. Note that, quality of the training target image may be stored in advance in the training storage unit 421 in association with the training target image. In this case, the first decision unit 423a may not estimate quality of the training target image.

The first decision unit 423a changes estimated quality regarding the training target image according to the training probability distribution, and decides training quality information.

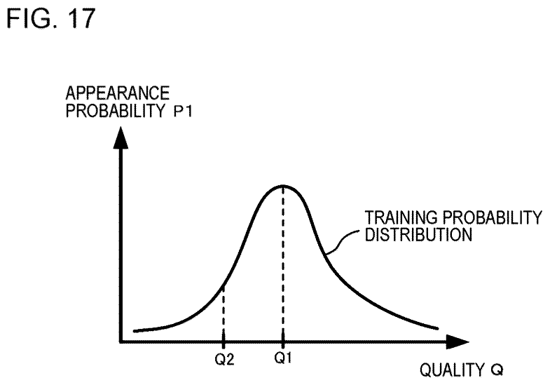

FIG. 17 is a diagram illustrating one example of a training quality distribution according to the example embodiment 4. A horizontal axis in FIG. 17 indicates quality Q. A vertical axis in FIG. 17 indicates an appearance probability P1.

Q1 in FIG. 17 is quality indicated by quality information of a training target image. A training probability distribution illustrated in FIG. 17 becomes a probability distribution in which the quality Q1 indicated by quality information of the training target image appears with a highest probability, and appears with a gradually decreasing probability, as a degree different from the quality increases. Further, the training probability distribution illustrated in FIG. 17 is an example of a probability distribution in which the probability is symmetric via the quality Q1 of the training target image.

The first decision unit 423a changes the quality Q1 of the training target image by generating a random number according to a training probability distribution as described above. Q2 in FIG. 17 is an example of training quality acquired based on the quality Q1 of the training target image, and a random number generated according to a training probability distribution. In this case, the first decision unit 423a changes the quality Q1 of the training target image, and thereby decides training quality information including the training quality Q2.

Note that, the training probability distribution is not limited to the probability distribution illustrated in FIG. 17. For example, generally, it is often a case that it is difficult to recognize with high performance by using a target image, as quality of the target image is lowered. Therefore, the training probability distribution may be a probability distribution on a probability with which low quality lower than the quality Q1 of a training target image becomes higher than high quality being higher than the quality Q1 of the training target image. Further, for example, the training probability distribution may be a probability distribution on a probability with which high quality becomes higher than low quality than the quality Q1. Further, the training policy decision unit 423 may decide a plurality of network policies regarding one training target image.

FIG. 16 is referred to again.

The second decision unit 423b decides a network policy regarding the training target image according to the training quality information decided in step S402a (step S402b).

Specifically, for example, the second decision unit 423b may decide a network policy according to the training quality information decided in step S402a, as a network policy regarding the training target image.

The training unit 422 inputs, to the neural network NN1 according to the network policy decided in step S402b, the training target image acquired in step S401. Thus, the training unit 422 performs training of the neural network NN1 (step S403), and finishes the training processing.

In training by the training unit 422, a general machine training technique may be used. For example, the training unit 422 may estimate features of a training target image by using the neural network NN1 according to a network policy. Then, the training unit 422 may derive a loss function for computing an error (loss) between the estimated features, and a correct answer value of the training target image. As the loss, for example, an intersection entropy (error), a mean square error, a mean absolute error (MAE), or the like may be used. The training unit 422 may derive a gradient, based on the loss function, and update a parameter included in the neural network NN1.

Note that, the training policy decision unit 423 may acquire a plurality of training target images in step S401. In this case, the training policy decision unit 423 and the training unit 422 may perform steps S402 and S403 regarding each of the training target images.

### Advantageous Effect

As described above, according to the present example embodiment, the information processing system 400 further includes the training unit 422 that performs training of the neural network NN1 by inputting a training target image to the neural network NN1.

Thus, training of the neural network NN1 can be performed.

According to the present example embodiment, the information processing system 400 further includes the training policy decision unit 423 that decides, based on quality information of a training target image, and a training probability distribution, a network policy regarding the training target image. The training unit 422 performs training of the neural network NN1 by inputting the training target image to the neural network NN1 according to the decided network policy. The training probability distribution is a probability distribution in which a probability becomes highest at quality indicated by quality information of a training target image, and a probability is gradually lowered, as a degree different from the quality increases.

Generally, the quality estimation unit 111 has a possibility of erroneously estimating quality of a target image. According to the present example embodiment, it is possible to perform, based on a training target image, training of the neural network NN1 associated with training quality mainly including quality of the training target image, and quality of a periphery thereof. Thus, even in a case where quality of a target image is erroneously estimated, it is possible to perform training for image processing (e.g., extraction of features using the neural network NN1) capable of performing recognition with high performance. Therefore, it becomes possible to perform high-performance recognition without depending on quality of a target image.

According to the present example embodiment, the training policy decision unit 423 includes the first decision unit 423a, and the second decision unit 423b. The first decision unit 423a changes quality information of a training target image according to a training probability distribution by using a random number, and decides training quality information. The second decision unit 423b decides a network policy regarding the training target image according to the decided training quality information.

Thus, it is possible to perform, based on a training target image, training of the neural network NN1 associated with training quality manly including quality of the training target image, and quality of a periphery thereof. Therefore, as described above, it becomes possible to perform high-performance recognition without depending on quality of a target image.

### Example Embodiment 5

In an example embodiment 5, another example of a training method of neural networks NN1 to NN3 is described. In the present example embodiment, a training method of the neural network NN1 according to the example embodiment 1 is described as an example. Further, in the present example embodiment, to simplify description, description overlapping the above-described example embodiments is omitted as appropriate.

### Configuration Example of Information Processing System 500 According to Example Embodiment 5

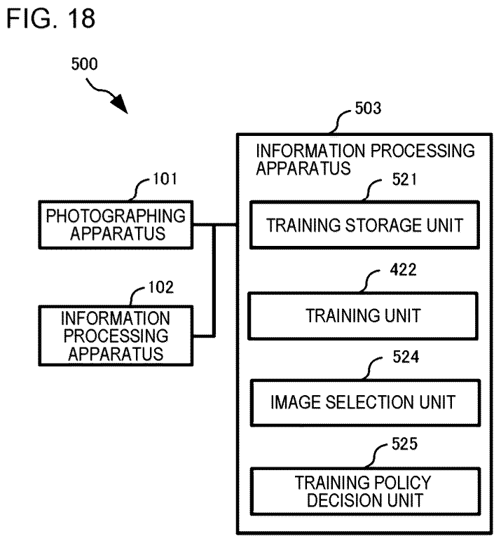

FIG. 18 is a diagram illustrating a configuration example of an information processing system 500 according to the example embodiment 5. The information processing system 500 includes an information processing apparatus 503, in addition to a photographing apparatus 101 and an information processing apparatus 102 similar to those of the example embodiment 1.

The information processing apparatus 503 is an apparatus for performing training of the neural network NN1. The information processing apparatus 503 includes a training unit 422 substantially similar to that of the example embodiment 4, a training storage unit 521, an image selection unit 524, and a training policy decision unit 525.

The training storage unit 521 is a storage unit for storing in advance training data. The training data according to the present example embodiment may be associated with a plurality of training target images, and a correct answer value of each of the plurality of training target images. The plurality of training target images may include a training target image whose quality is different. Further, the training data according to the present example embodiment may be further associated with quality of each of the training target images.

The training unit 422 performs training of the neural network NN1 by inputting a training target image selected by the image selection unit 524 (details will be described later) to the neural network NN1.

The image selection unit 524 selects a training target image in such a way that a training target image of low quality is selected more. For example, the image selection unit 524 selects a training target image in such a way that a training target image of a low resolution is selected more, as compared with a training target image of a high resolution.

The training policy decision unit 525 decides, based on quality information of a training target image selected by the image selection unit 524, a network policy of the training target image selected by the image selection unit 524. The training policy decision unit 525 may decide a network policy of a training target image selected by the image selection unit 524 by using processing similar to processing for deciding a network policy by a policy decision unit 112.

The information processing apparatus 503 may be physically configured similarly to the information processing apparatus 102 (see FIG. 6). However, a storage device 1040 of the information processing apparats 503 stores a program module for achieving a function of the information processing apparatus 503. Further, a network interface 1050 of the information processing apparatus 503 is an interface for connecting the information processing apparatus 503 to a network.

### Operation Example of Information Processing System 500 According to Example Embodiment 5

The information processing system 500 performs information processing. The information processing according to the present example embodiment includes training processing, in addition to processing similar to that of the example embodiment 1. Similarly to the example embodiment 4, for example, the training processing is processing for performing training of the neural network NN1. For example, the information processing apparatus 503 starts training processing upon accepting an instruction of a user.

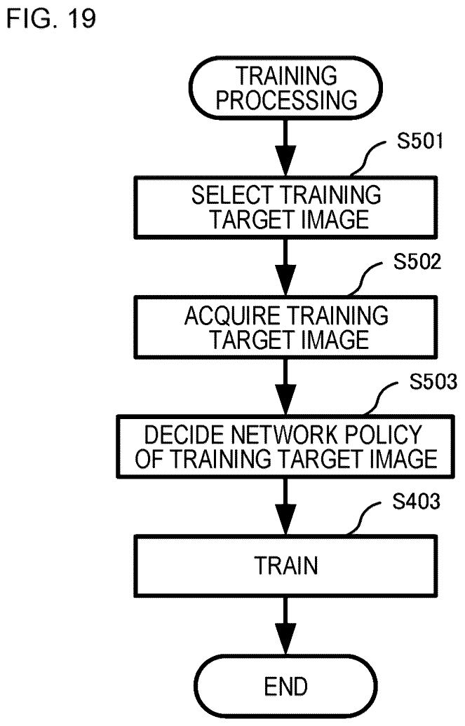

FIG. 19 is a flowchart illustrating one example of training processing according to the example embodiment 5.

The image selection unit 524 selects a training target image in such a way that a training target image of low quality is selected more from among training target images stored in the training storage unit 421 (step S501).

Specifically, for example, the image selection unit 524 may derive quality according to a selection probability distribution. The quality is, for example, a resolution of an image.

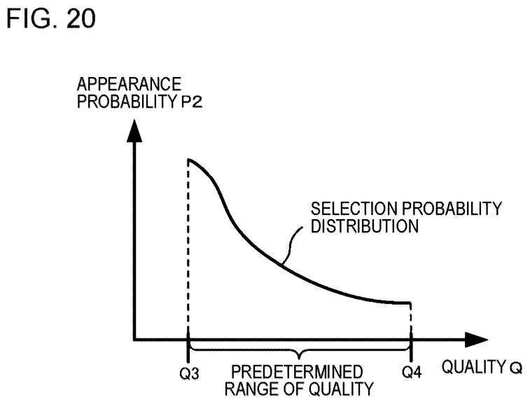

FIG. 20 is a diagram illustrating one example of a selection probability distribution according to the example embodiment 5. A horizontal axis in FIG. 20 indicates quality Q. A vertical axis in FIG. 20 indicates an appearance probability P2. The selection probability distribution is a probability distribution in which a probability becomes high, as quality is lowered in a predetermined range (in FIG. 20, a range from Q3 to Q4) of quality. A selection probability distribution as described above may be, for example, acquired by multiplying a predetermined weight by quality (e.g., a resolution).

Further, the image selection unit 524 may select, from among the training target images stored in the training storage unit 421, a training target image associated with the derived quality.

Note that, in a case where quality is not included in training data, for example, similarly to a quality estimation unit 111, the image selection unit 524 may estimate a target area position in a training target image, and estimate quality of the training target image. In this case, for example, the image selection unit 524 my select a training target image whose quality is estimated to be the same as the quality derived according to the selection probability distribution.

FIG. 19 is referred to again.

The image selection unit 524 acquires the training target image selected in step S501, for example, from the training storage unit 421 (step S502).

The training policy decision unit 525 decides, based on quality information of the training target image acquired in step S502, a network policy of the training target image acquired in step S502 (step S503).

Specifically, for example, the training policy decision unit 525 may acquire, from the image selection unit 524, quality information derived in step S501. Note that, the information processing apparatus 503 may further include a function similar to that of the quality estimation unit 111, and estimate quality information of the training target image acquired in step S502 by using the function.

Similarly to the example embodiment 4, the training unit 422 performs training of the neural network NN1 (step S403), and finishes the training processing.

In step S403 according to the present example embodiment, the training unit 422 inputs, to the neural network NN1 according to the network policy decided in step S504, the training target image acquired in step S502. Thus, the training unit 422 performs training of the neural network NN1.

### Advantageous Effect

As described above, according to the present example embodiment, the information processing system 500 further includes the image selection unit 524 that selects a training target image in such a way that a training target image of low quality is selected more. The training unit 422 performs training of the neural network NN1 by inputting the selected training target image to the neural network NN1.

Generally, it is often a case that it is difficult to recognize with high performance by using a target image, as quality of the target image is lowered. According to the present example embodiment, since a training target image of low quality is selected more, it is possible to perform training more in the neural network NN1 associated with low quality. Thus, even in a case where quality of a target image is low, it is possible to perform training for image processing (e.g., extraction of features using the neural network NN1) capable of performing high-performance recognition. Therefore, it becomes possible to perform high-performance recognition without depending on quality of a target image.

### Example Embodiment 6

The training methods described in the example embodiments 4 and 5 may be combined with each other. In an example embodiment 6, as still another example of a training method of neural networks NN1 to NN3, an example in which the training methods described in the example embodiments 4 and 5 are combined with each other is described. In the present example embodiment, a training method of the neural network NN1 according to the example embodiment 1 is described as an example. Further, in the present example embodiment, to simplify description, description overlapping the above-described example embodiments is omitted as appropriate.

### Configuration Example of Information Processing System 600 According to Example Embodiment 6

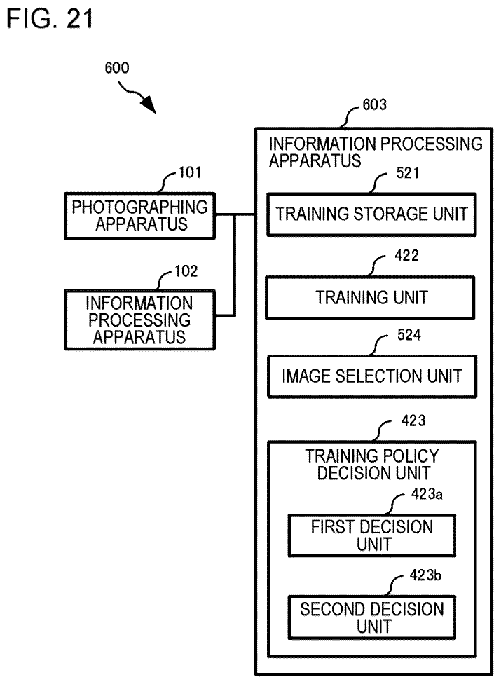

FIG. 21 is a diagram illustrating a configuration example of an information processing system 600 according to the example embodiment 6. The information processing system 600 includes an information processing apparatus 603, in addition to a photographing apparatus 101 and an information processing apparatus 102 similar to those of the example embodiment 1.

The information processing apparatus 603 is an apparatus for performing training of the neural network NN1. The information processing apparatus 603 includes a training unit 422 and a training policy decision unit 423 substantially similar to those of the example embodiment 4, and a training storage unit 521 and an image selection unit 524 substantially similar to those of the example embodiment 5.

The training policy decision unit 423 according to the present example embodiment decides, based on quality information of a training target image selected by the image selection unit 524, and a training probability distribution, a network policy regarding the training target image.

As described in the example embodiment 4, the training policy decision unit 423 may include a first decision unit 423a, and a second decision unit 423b. Specifically, the first decision unit 423a may change quality information of a training target image selected by the image selection unit 524 according to a training probability distribution by using a random number, and decide training quality information. The second decision unit 423b may decide a network policy regarding the training target image according to the training quality information decided by the first decision unit 423a.

The information processing apparatus 603 may be physically configured similarly to the information processing apparatus 102 (see FIG. 6). However, a storage device 1040 of the information processing apparats 603 stores a program module for achieving a function of the information processing apparatus 603. Further, a network interface 1050 of the information processing apparatus 603 is an interface for connecting the information processing apparatus 603 to a network.

### Operation Example of Information Processing System 600 According to Example Embodiment 6

The information processing system 600 performs information processing. The information processing according to the present example embodiment includes training processing, in addition to processing similar to that of the example embodiment 1. Similarly to the example embodiment 4, for example, the training processing is processing for performing training of the neural network NN1. For example, the information processing apparatus 603 starts training processing upon accepting an instruction of a user.

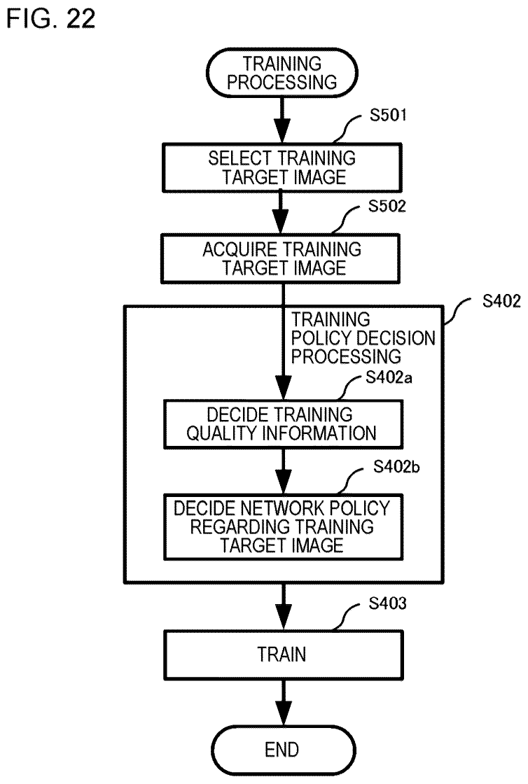

FIG. 22 is a flowchart illustrating one example of training processing according to the example embodiment 6.

The image selection unit 524 performs steps S501 and S502 similar to those of the example embodiment 5.

The training policy decision unit 423 performs training policy decision processing (step S402) substantially similar to that of the example embodiment 4.

A training target image serving as a processing target in step S402 according to the present example embodiment is, for example, a training target image acquired in step S502. Specifically, in step S402 according to the present example embodiment, the training policy decision unit 423 decides a network policy regarding the training target image acquired in step S502.

Quality information of the training target image for use in step S402 according to the present example embodiment may be quality information derived in step S501. In this case, the training policy decision unit 423 may acquire quality information of the training target image from the image selection unit 524. Note that, the information processing apparatus 603 may further include a function similar to that of a quality estimation unit 111, and estimate quality information of the training target image acquired in step S502 by using the function. In this case, the estimated quality information may be used in processing in step S402, as quality of the training target image.

The training unit 422 performs processing of step S403 substantially similar to that of the example embodiment 4, and finishes the training processing.

Specifically, for example, the training unit 422 may input, to the neural network NN1 according to a network policy decided in step S402b, the training target image acquired in step S502. Thus, the training unit 422 may perform training of the neural network NN1.

### Advantageous Effect

As described above, according to the present example embodiment, the information processing system 600 includes the image selection unit 524, the training policy decision unit 423, and the training unit 422.

The image selection unit 524 selects a training target image in such a way that a training target image of low quality is selected more.

The training policy decision unit 423 decides, based on quality information of a training target image, and a training probability distribution, a network policy regarding the training target image. The training probability distribution is a probability distribution in which a probability becomes highest at quality indicated by quality information of a training target image, and a probability is gradually lowered, as a degree different from the quality increases.

The training unit 422 performs training of the neural network NN1 by inputting a selected training target image to the neural network NN1 according to a decided network policy.

Thus, as described in the example embodiment 4, even in a case where quality of a target image is erroneously estimated, it is possible to perform training for image processing (e.g., extraction of features using the neural network NN1) capable of performing high-performance recognition. Further, as described in the example embodiment 5, even in a case where quality of a target image is low, it is possible to perform training for image processing (e.g., extraction of features using the neural network NN1) capable of performing high-performance recognition. Therefore, it becomes possible to more perform high-performance recognition without depending on quality of a target image.

In the foregoing, example embodiments and modification examples according to the present invention have been described with reference to the drawings, however, these are examples of the present invention, and various configurations other than the above can also be adopted.

Further, in a plurality of flowcharts used in the above description, a plurality of processes (pieces of processing) are described in order, however, the order of execution of processes to be executed in each example embodiment is not limited to the order of description. In each example embodiment, the illustrated order of processes can be changed within a range that does not adversely affect a content. Further, the above-described example embodiments and modification examples can be combined, as far as contents do not conflict with each other.

A part or all of the above-described example embodiments may also be described as the following supplementary notes, but is not limited to the following.
1. An information processing system including:
   a quality estimation unit that estimates quality information of a target image; and
   an image processing unit that processes the target image by using a neural network according to a network policy to be decided based on quality information of the target image.
2. The information processing system according to supplementary note 1, wherein
   the image processing unit extracts features from the target image by using the neural network according to the network policy.
3. The information processing system according to supplementary note 1 or 2, wherein
   the target image is an eye image including an iris area in which an iris is reflected, and
   the quality information includes an iris diameter.
4. The information processing system according to any one of supplementary notes 1 to 3, wherein
   the quality information includes a resolution of the target image.
5. The information processing system according to any one of supplementary notes 1 to 4, further including
   a policy decision unit that decides the network policy, based on the quality information.
6. The information processing system according to supplementary note 5, wherein
   the policy decision unit decides the network policy in such a way that processing time using the neural network lies within a predetermined range, regardless of quality information of the target image.
7. The information processing system according to any one of supplementary notes 1 to 6, wherein
   the image processing unit includes
   a first processing unit that converts the iris area included in the target image into a standard image of a predetermined shape, and
   a second processing unit that processes the standard image by using the neural network according to the network policy, and
   the first processing unit converts the iris area into the standard image of a size according to the quality information.
8. The information processing system according to any one of supplementary notes 1 to 7, wherein
   the neural network is configured of a first stage group including an input layer, and a last stage group including a last layer, and
   the network policy is applied to image processing using the first stage group.
9. The information processing system according to supplementary note 8, wherein
   the neural network includes a plurality of convolutional layers, and
   the policy decision unit decides the network policy in such a way as to increase a number of the convolutional layers included in the first stage group, as a resolution of the targe image is lowered.
10. The information processing system according to supplementary note 8, wherein
   the neural network includes a plurality of convolutional layers, and
   the policy decision unit decides the network policy in such a way as to increase a channel number in computation on the convolutional layer included in the first stage group, as a resolution of the target image is lowered.
11. The information processing system according to any one of supplementary notes 1 to 10, further including
   a training unit that performs training of the neural network by inputting a training target image to the neural network.
12. The information processing system according to supplementary note 11, further including
   a training policy decision unit that decides a network policy regarding the training target image, based on quality information of the training target image and a training probability distribution, wherein
   the training unit performs training of the neural network by inputting the training target image to the neural network according to the decided network policy, and
   the training probability distribution is a probability distribution in which a probability becomes highest at quality indicated by quality information of the training target image, and a probability is gradually lowered, as a degree different from the quality increases.
13. The information processing system according to supplementary note 12, wherein
   the training policy decision unit includes
   a first decision unit that changes quality information of the training target image according to a training probability distribution by using the random number, and decides training quality information, and
   a second decision unit that decides a network policy regarding the training target image according to the decided training quality information.
14. The information processing system according to any one of supplementary notes 11 to 13, further including
   an image selection unit that selects a training target image in such a way that a training target image of low quality is selected more, wherein
   the training unit performs training of the neural network by inputting the selected training target image to the neural network.
15. An information processing apparatus including:
   a quality estimation unit that estimates quality information of a target image; and
   an image processing unit that processes the target image by using a neural network according to a network policy to be decided based on quality information of the target image.
16. An information processing method including,
   by one or more computers:
   estimating quality information of a target image; and
   processing the target image by using a neural network according to a network policy to be decided based on quality information of the target image.
17. A medium recording a program for causing one or more computers to execute:
   estimating quality information of a target image; and
   processing the target image by using a neural network according to a network policy to be decided based on quality information of the target image.

### REFERENCE SIGNS LIST

100, 400, 500, 600 Information processing system
101 Photographing apparatus
102, 403, 503, 603 Information processing apparatus
111 Quality estimation unit
112 Policy decision unit
113 Image processing unit
113a First processing unit
113b Second processing unit
114 Recognition unit
421, 521 Training storage unit
422 Training unit
423 Training policy decision unit
423a First decision unit
423b Second decision unit
524 Image selection unit
525 Training policy decision unit
NN1 to NN3 Neural network

What is claimed is:

1. An information processing system comprising:
at least one memory storing instructions; and
at least one processor configured to execute the instructions to:
estimate quality information of a target image; and
process the target image by using a neural network according to a network policy to be decided based on quality information of the target image.

2. The information processing system according to claim 1, wherein
processing the target image includes extracting features from the target image by using the neural network according to the network policy.

3. The information processing system according to claim 1, wherein
the target image is an eye image including an iris area in which an iris is reflected, and
the quality information includes an iris diameter.

4. The information processing system according to claim 1, wherein
the quality information includes a resolution of the target image.

5. The information processing system according to claim 1, wherein the at least one processor further configured to execute the instructions to:
decide the network policy, based on the quality information.

6. The information processing system according to claim 5, wherein
deciding the network policy includes deciding the network policy in such a way that processing time using the neural network lies within a predetermined range, regardless of quality information of the target image.

7. The information processing system according to claim 1, wherein
processing the target image includes
converting the iris area included in the target image into a standard image of a predetermined shape, and
processing the standard image by using the neural network according to the network policy, and
converting the iris area into the standard image of a size according to the quality information.

8. The information processing system according to claim 1, wherein
the neural network is configured of a first stage group including an input layer, and a last stage group including a last layer, and
the network policy is applied to image processing using the first stage group.

9. The information processing system according to claim 8, wherein
the neural network includes a plurality of convolutional layers, and
deciding the network policy includes deciding the network policy in such a way as to increase a number of the convolutional layers included in the first stage group, as a resolution of the targe image is lowered.

10. The information processing system according to claim 8, wherein
the neural network includes a plurality of convolutional layers, and
deciding the network policy includes deciding the network policy in such a way as to increase a channel number in computation on the convolutional layer included in the first stage group, as a resolution of the target image is lowered.

11. The information processing system according to claim 1, wherein the at least one processor further configured to execute the instructions to:
perform training of the neural network by inputting a training target image to the neural network.

12. The information processing system according to claim 11, wherein the at least one processor further configured to execute the instructions to:
decide a network policy regarding the training target image, based on quality information of the training target image and a training probability distribution, wherein
training unit performs training of the neural network is performed by inputting the training target image to the neural network according to the decided network policy, and
the training probability distribution is a probability distribution in which a probability becomes highest at quality indicated by quality information of the training target image, and a probability is gradually lowered, as a degree different from the quality increases.

13. The information processing system according to claim 12, wherein
deciding the network policy includes
changing quality information of the training target image according to a training probability distribution by using a random number,
deciding training quality information, and
deciding a network policy regarding the training target image according to the decided training quality information.

14. The information processing system according to claim 11, wherein the at least one processor further configured to execute the instructions to:
select a training target image in such a way that a training target image of low quality is selected more, wherein
training of the neural network is performed by inputting the selected training target image to the neural network.

15. (canceled)

16. An information processing method comprising,
by one or more computers:
estimating quality information of a target image; and
processing the target image by using a neural network according to a network policy to be decided based on quality information of the target image.

17. A non-transitory computer readable medium recording a program for causing one or more computers to execute:
estimating quality information of a target image; and
processing the target image by using a neural network according to a network policy to be decided based on quality information of the target image.
